(19) United States
(12) Patent Application Publication
(10) Pub. No.: US 2003/0199412 A1
(43) Pub. Date: Oct. 23, 2003

(54) Fragrance containing cleaning product

(76) Inventors: Gargi Gupta, East Hanover, NJ (US); Matthias Lammert, Nanuet, NY (US); Keith McDermott, Bound Brook, NJ (US)

Correspondence Address: BAYER POLYMERS LLC, 100 BAYER ROAD, PITTSBURGH, PA, 15205, US

(21) Appl. No.: 10/124,492

(22) Filed: Apr. 17, 2002

(51) Int. Cl. C11D 17/00

(52) U.S. Cl. 510/285; 510/424; 510/426; 510/421; 510/446; 510/475

(57) ABSTRACT

Fragrance containing compositions are capable of being combined with powder compositions to provide for a product having cleaning, disinfecting and air freshening properties. A cleaning product having a fragrance composition incorporated therein can be hand held or attached to a device for cleaning.

### FIELD OF THE INVENTION

The present invention relates to a powder composition having cleaning, disinfecting and air freshening properties. Specifically, the present invention relates to a powder composition containing a fragrance delivery system comprising a starch matrix throughout which tiny droplets of fragrance oil are distributed. Powder compositions of the present invention provide cleaning and/or disinfecting and/or bleaching and/or room-scenting properties. Further, the powder compositions of the present invention contain spray-dried fragrances that are activated by moisture.

The powder compositions of the present invention can be filled in a dry pouch suitable to be flushed away through a toilet plumbing system. The dry cleaning pouch of the present invention can be handheld for cleaning kitchen and bath surfaces or alternatively, it can be attached to a stick device for cleaning a toilet bowl, or other surfaces, and detached from the stick device without requiring the individual operating the device to manually touch the pouch.

### BACKGROUND OF THE INVENTION

Various self-cleaning sponges and brushes are known. These self-cleaning sponges contain a liquid or powder detergent that can be discharged while in use. Generally, these sponges are designed for multiple uses and therefore they are stored on sinks and countertops where germs and malodors are collected.

Similarly, various types of toilet bowl cleaning systems and products are known. Normally, toilet bowls are cleaned by wiping the bowl with a special brush and a detergent in the form of a liquid or a powder, the detergent is applied out of a separate container into the toilet, or onto the brush. After cleaning the toilet bowl, the brush is dripping wet and is normally stored in a separate container. The wet brush and storage container contains germs and emits an unpleasant odor into the air.

Toilet bowls can also be cleaned with automatic cleaners, which are placed in the bowl or the tank of the toilet. These systems generally are not as effective as manual cleaning. Another flaw with these systems is that automatic cleaners normally give no indication as to when they need to be replaced.

It is also known in the art to combine disposable cleaning pads with holders for use in cleaning toilet bowls, however it is not known to combine the fragrance delivery system of the present invention to provide fragrance stability over an extended period of time.

Therefore, there remains a need for a disposable pouch containing a fragrance delivery system comprising a powder composition that can be hand held or connected to a stick device for cleaning kitchen and bathroom surfaces, including toilet bowls.

### SUMMARY OF THE INVENTION

The present invention relates to a powder composition containing a fragrance delivery system, which can be incorporated into a dry pouch of a material suitable to be flushed away through toilet-plumbing systems. The powder composition contains both solid constituents and liquid constituents and the liquid constituents are absorbed in a suitable matrix material.

### DETAILED DESCRIPTION OF THE INVENTION

Powder compositions of the present invention contain an effective amount of an anionic surfactant and an effective amount of a fragrance composition in what will hereinafter be referred to as the fragrance delivery system. Typically, from about 0.01% to about 99.9% by weight of the powder composition is an anionic surfactant, preferably from about 1% to about 80%, more preferably from about 5% to about 50% by weight of the composition is the anionic surfactant. Typically, from about 0.01% to about 60% by weight of the powder composition is the fragrance composition, preferably from about 0.01% to about 30% and more preferably from about 0.05% to about 25%.

Suitable surfactants that may be used are generally commercially available. Preferred surfactants include alkylbenzenesulfonate salts, alkyl ether sulfate salts, alkyl sulfate salts, sulfosuccinate salts, paraffin sulfonate salts, alpha olefin sulfonate salts, methyl ester sulfonate salts, alkyl polyglycol phosphate salts and mixtures thereof.

Generally, the liquid fragrance composition is dispersed throughout a water soluble matrix material. Such fragrance composition ingredients according to the present invention can be found, for example, in S. Arctander, Perfume and Flavor Materials, Vols. I and 11, Monclair, N. N., 1969, Selbstverlag or K. Bauer, D. Garbe and H. Surburg, Common Fragrances and Flavor Materials, 3^{rd} Ed., Wiley-VCH, Weinheim 1997.

The following are examples of fragrance composition ingredients:

extracts from natural raw materials such as essential oils, concretes, absolutes, resins, resinoids, balsams, tinctures such as for example ambergris tincture; amyris oil; angelica seed oil; angelica root oil; aniseed oil; valerian oil; basil oil; tree moss absolute; bay oil; armoise oil; benzoe resinoid; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedar wood oil; cistus oil; citronella oil; lemon oil; copaiba balsam; copaiba balsam oil; coriander oil; costus root oil; cumin oil; cypress oil; davana oil; dill weed oil; dill seed oil; eau de brouts absolute; oakmoss absolute; elemi oil; estragon oil; eucalyptus citriodora oil; eucalyptus oil (cineole type); fennel oil; fir needle oil; galbanum oil; galbanum resin; geranium oil; grapefruit oil; guaiacwood oil; gurjun balsam; gurjun balsam oil; helichrysum absolute; helichrysum oil; ginger oil; iris root absolute; iris root oil; jasmine absolute; calamus oil; blue camomile oil; Roman camomile oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemon-grass oil; lovage oil; lime oil distilled; lime oil expressed; linaloe oil; Litsea cubeba oil; laurel leaf oil; mace oil; marjoram oil; mandarin oil; massoi (bark) oil; mimosa absolute; ambrette seed oil; musk tincture; clary sage oil; nutmeg oil; myrrh absolute; myrrh oil; myrtle oil; clove leaf oil; clove bud oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil: spike-lavender oil; star anise oil; storax oil; tagetes oil; fir needle oil; tea tree oil; turpentine oil; thyme oil; Tolu balsam; tonka bean absolute; tuberose absolute; vanilla extract; violet leaf absolute; verbena oil; vetiver oil; juniperberry oil; wine lees oil; wormwood oil; wintergreen oil; ylang-ylang oil; hyssop oil; civet absolute; cinnamon leaf oil; cinnamon bark oil; and fractions thereof or ingredients isolated therefrom;

individual fragrance ingredients from the group comprising hydrocarbons, such as for example 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

aliphatic alcohols, such as for example hexanol; octanol; 3-octanol; 2,6-dimethylheptanol; 2-methyl-2-heptanol, 2-methyl-2-octanol; (E)-2-hexenol; (E)- and (Z)-3-hexenol; 1-octen-3-ol; a mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol; aliphatic aldehydes and their acetals such as for example hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-5,9-undecadienal; heptanal-diethylacetal; 1,1-dimethoxy-2,2,5-trimethyl-4-hexene; citronellyl oxyace-taldehyde;

aliphatic ketones and oximes thereof, such as for example 2-hepta-none; 2-octanone; 3-octanone; 2-nonanone; 5-methyl-3-heptanone; 5-methyl-3-heptanone oxime; 2,4,4,7-tetramethyl-6-octen-3-one; aliphatic sulfur-containing compounds, such as for example 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol; aliphatic nitriles, such as for example 2-nonenenitrile; 2-tridecenenitrile; 2,12-tridecenenitrile; 3,7-dimethyl-2,6-octadienenitrile; 3,7-dimethyl-6-octenenitrile;

aliphatic carboxylic acids and esters thereof, such as for example (E)- and (Z)-3-hexenylformate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexylbutyrate; (E)- and (Z)-3-hexenyl isobutyrate; hexyl crotonate; ethylisovalerate; ethyl-2-methyl pentanoate; ethyl hexanoate; allyl hexanoate; ethyl heptanoate; allyl heptanoate; ethyl octanoate; ethyl-(E,Z)-2,4-decadienoate; methyl-2-octinate; methyl-2-noninate; allyl-2-isoamyl oxyacetate; methyl-3,7-dimethyl-2,6-octadienoate;

acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol 2,6-dimethyl-2,5,7-octatrien-1-ol; as well as formates, acetates, propionates, isobutyrates, butyrates, isovalerates, pentanoates, hexanoates, crotonates, tiglinates and 3-methyl-2-butenoates thereof;

acyclic terpene aldehydes and ketones, such as, for example, geranial; neral; citronellal; 7-hydroxy-3,7-dimethyloctanal; 7-methoxy-3,7-dimethyloctanal; 2,6,10-trimethyl-9-undecenal; α-sinensal; β-sinensal; geranylacetone; as well as the dimethyl- and diethylacetals of geranial, neral and 7-hydroxy-3,7-dimethyloctanal;

cyclic terpene alcohols, such as, for example, menthol; isopulegol; alpha-terpineol; terpinen-4-ol; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates and 3-methyl-2-butenoates of alpha-terpineol; terpinen-4-ol; methan-8-ol; methan-1-ol; methan-7-ol; borneol; isoborneol; linalool oxide; nopol; cedrol; ambrinol; vetiverol; guaiol;

cyclic terpene aldehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; nootkatone; dihydronootkatone; acetylated cedarwood oil (cedryl methyl ketone);

cyclic alcohols, such as, for example, 4-tert.-butylcyclohexanol; 3,3,5-trimethylcyclohexanol; 3-isocamphylcyclohexanol; 2,6,9-trimethyl- Z2,Z5,E9-cyclododecatrien-1-ol; 2-isobutyl-4-methyltetrahydro-2H-pyran-4-ol;

cycloaliphatic alcohols, such as, for example, alpha,3,3-trimethylcyclo-hexylmethanol; 2-methyl-4-(2,2,3-trimethyl-3-cyclopent-1- yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;

cyclic and cycloaliphatic ethers, such as, for example, cineole; cedryl methyl ether; cyclododecyl methyl ether;

(ethoxymethoxy)cyclododecane; alpha-cedrene epoxide; 3a,6,6,9a-tetramethyldodecahydronaphtho[2,1-b]furan; 3a-ethyl-6,6,9a-trimethyl-dodecahydronaphtho[2,1-b]furan; 1,5,9-trimethyl-13-oxabicyclo[10.1.0]-trideca-4,8-diene; rose oxide; 2-(2,4-dimethyl-3-cyclohexen-1-yl)-5-methyl-5-(1-methylpropyl)-1,3-dioxan;

cyclic ketones, such as, for example, 4-tert.-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-yl-2-cyclopenten-1-one; 3-methyl-2-pentyl-2-cyclopenten-1-one; 3-methyl-4-cyclopentadecenone; 3-methyl-5-cyclopentadecenone; 3- methylcyclopentadecanone; 4-(1-ethoxyvinyl)-3,3,5,5-tetramethylcyclo-hexanone; 4-tert.-pentylcyclohexanone; 5-cyclohexadecen-1-one; 6,7-dihydro-1,1,2,3,3-pentamethyl-4(5H)-indanone; 5-cyclohexadecen-1-one; 8-cyclohexadecen-1-one; 9-cycloheptadecen-1-one; cyclopentadecanone;

cycloaliphatic aldehydes, such as, for example, 2,4-dimethyl-3-cyclohexene carbaldehyde; 2-methyl-4-(2,2,6-trimethyl-cyclohexen-1-yl)-2-butenal; 4-(4-hydroxy-4-methylpentyl)-3-cyclohexene carbaldehyde; 4-(4-methyl-3-penten-1-yl)-3-cyclohexene carbaldehyde;

cycloaliphatic ketones, such as, for example, 1-(3,3-dimethylcyclohexyl)-4-penten-1-one; 1-(5,5-dimethyl-1-cyclohexen-1-yl)-4-penten-1-one; 2,3,8,8-tetramethyl-1,2,3,4,5,6,7,8-octahydro-2-naphtalenyl methyl ketone; methyl-2,6,10-trimethyl-2,5,9-cyclododecatrienyl ketone; tert.-butyl-(2,4-dimethyl-3-cyclohexen-1-yl)ketone;

esters of cyclic alcohols, such as, for example, 2-tert.-butylcyclohexyl acetate; 4-tert.-butylcyclohexyl acetate; 2-tert.-pentylcyclo-hexyl acetate; 4-tert.-pentylcyclohexyl acetate; decahydro-2-naphthyl acetate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl-isobutyrate; 4,7-methanooctahydro-5 or 6-indenyl acetate;

esters of cycloaliphatic carboxylic acids, such as, for example, allyl 3-cyclohexyl-propionate; allyl cyclohexyl oxyacetate; methyl dihydrojasmonate; methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolane-2-acetate;

araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate; araliphatic ethers, such as for example 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;

aromatic and araliphatic aldehydes, such as, for example, benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert.-butylphenyl)propanal; 3-(4-tert.-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylene-dioxybenzaldehyde; 3,4-dimethoxybenzaldehyde; 2-methyl-3-(4-methoxyphenyl)propanal; 2-methyl-3-(4-methylendioxyphenyl)propanal;

aromatic and araliphatic ketones, such as, for example, acetophenone; 4-methylacetophenone; 4-methoxyacetophenone; 4-tert.-butyl-2,6-dimethylacetophenone; 4-phenyl-2-butanone; 4-(4-hydroxyphenyl)-2-butanone; 1-(2-naphthalenyl)ethanone; benzophenone; 1,1,2,3,3,6-hexamethyl-5-indanyl methyl ketone; 6-tert.-butyl-1,1-dimethyl-4-indanyl methyl ketone; 1-[2,3-dihydro-1,1,2,6-tetramethyl-3-(1-methyl-ethyl)-1H-5-indenyl]ethanone; 5′,6′,7′,8′-tetrahydro-3′,5′,5′,6′,8′,8′-hexa-methyl-2-acetonaphthone;

aromatic and araliphatic carboxylic acids and esters thereof, such as, for example, benzoic acid; phenylacetic acid; methyl benzoate; ethyl benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;

nitrogen-containing aromatic compounds, such as, for example, 2,4,6-trinitro-1,3-dimethyl-5-tert.-butylbenzene; 3,5-dinitro-2,6-dimethyl-4-tert.-butylacetophenone; cinnamonitrile; 5-phenyl-3-methyl-2-pentenonitrile; 5-phenyl-3-methylpentanonitrile; methyl anthranilate; methy-N-methylanthranilate; Schiff's bases of methyl anthranilate with 7-hydroxy-3,7-dimethyloctanal, 2-methyl-3-(4-tert.-butylphenyl)propanal or 2,4-dimethyl-3-cyclohexene carbaldehyde; 6-isopropylquinoline; 6-isobutylquinoline; 6-sec.-butylquinoline; indole; skatole; 2-methoxy-3-isopropylpyrazine; 2-isobutyl-3-methoxypyrazine;

phenols, phenyl ethers and phenyl esters, such as, for example, estragole; anethole; eugenol; eugenyl methyl ether; isoeugenol; isoeugenol methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;

heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

The fragrance system may also contain materials having no odor or very faint odor, which are known as diluents or extenders. Non-limiting examples of these materials are dipropylene glycol, diethyl phthalate, triethyl citrate, isopropyl myristate, and benzyl benzoate. These materials are used for, diluting and stabilizing some other perfume ingredients. These diluents are considered to be additional ingredients and not considered as a fragrance ingredient.

Also, the fragrance system includes other non-odorous active ingredients. Some non-limiting examples are: anti-microbial ingredients, and optical brighteners.

Suitable matrix materials include starches, and/or modified starches and/or polyvinyl alcohol or the like. Alternatively, suitable porous solids can absorb the liquid fragrance composition. Suitable porous solids include spray dried porous salts such as spray dried sodium sulfate, as well as starches, clays, fumed silicas or mixtures thereof.

Due to the cleaning composition being stored in a porous pouch, fragrance evaporation may occur during storage and may lead to a substantial loss of fragrance materials before the product is used. In order to prevent such loss of volatile aroma chemicals and to ensure the desired fragrance and malodor coverage in use, the liquid fragrance mixture is dispersed throughout the matrix. This dispersion is generally referred to as a spray dried fragrance. Spray dried fragrances are activated by moisture while traditional encapsulated fragrance compositions are activated by mechanical stimuli such as heat.

Sprayed dried fragrances can be produced by any method known in the art. Generally, the sprayed dried fragrance compositions contain a modified starch, fragrance oils and other additives such as oligosaccharides, polyvinyl alcohol and multodextrin. Preferably spray dried fragrances of the present invention are produced by the INCAP HC System (Haarmann & Reimer), the Fast-Cap M System and the Polycap® (Haarmann & Reimer) HC System.

Optionally, the powder composition may further contain an effective amount of a nonionic surfactant to improve the cleaning performance of the composition. Preferably from about 0.01% to about 50% by weight of the powder composition is a nonionic surfactant, more preferably from about 0.1% to about 15%. Suitable nonionic surfactants include, ethoxylated aliphalic alcohols, ethoxylated alkyl phenols, ethoxylated carboxylic acids, polyethylene glycol diesters of fatty acids, fatty acid esters of ethoxylated sorbitans, alkyl polyglycosides, polypropylene glycol-polyethylene glycol block copolymers and mixtures thereof.

Optionally, the powder composition may further contain an effective amount of an amphoteric surfactant to improve the cleaning performance of the composition. Preferably from about 0.01% to about 30% by weight of the composition is an amphoteric surfactant, more preferably from about 0.1% to about 15% by weight of the composition is an amphoteric surfactant. The amphoteric surfactant can be chosen from the group of betaines.

Optionally, the powder composition may further contain an effective amount of an anti-microbial agent to provide antimicrobial properties to the powder composition. Preferably, the anti-microbial agent is from about 0.01% to about 30% by weight of the composition, more preferably from about 0.1% to about 15% by weight of the composition. Suitable anti-microbial agents include cationic surfactants such as, alkyl dimethyl benzyl ammonium chlorides, para-hydroxybenzoic acid (parabens), 2,4,4′-trichlro-2′hydroxy diphenyl ether (triclosan) and mixtures thereof, other antimicrobial compounds with sufficient good water solubility and/or oxidizing compounds such as hypochlorite salts, peroxide compounds, percarbonate salts, perborate salts and mixtures thereof. Additionally, the oxidizers listed above comprise an additional bleaching and cleaning effect.

Optionally, the powder composition may further contain a builder substance to provide water softening and conditioning properties to support the cleaning action of the composition. The composition contains by weight from about 0.1% to about 80%, preferably from about 1% to about 60% and more preferably from about 2% to about 40% of the builder substance. Suitable builder compositions include citric acid, polyphosphates, polycarboxylates, carbonates, aluminosilicates (Zeolites), phosphonic acids, nitrilotriacetic acids, ethylenediamine tetraacetic acid, sesquicarbonates, bicarbonates, and sodium silicates.

Optionally, the powder composition may further comprise a buffer substance to maintain a high pH of the generated cleaning solution. The composition contains by weight from about 0.1% to about 60%, preferably from about 0.5% to about 40%, more preferably from about 1% to about 30% of the buffer substance. Suitable buffer compounds can be carbonates, bicarbonates, sesquicarbonates, phosphates, polyphosphates, metal hydroxides and mixtures thereof.

The powder composition of the present invention can be filled into a hollow pouch made of a cellulose paper material. The pouch can be designed to be handheld or the pouch can be of such a shape that can be attached to a stick device by any known means. For example, the pouch may comprise a rim under which a stick device can spread mobile plates for the purpose of linking the pouch to the stick. After use, such pouch can be released by any known mechanical means, preferably by a release mechanism which switches the plates and pushes the pouch away from the stick device into the toilet bowl to be flushed through the plumbing system.

The pouch can be made out of a biodegradable cellulose material. Any glues used for the manufacture of the pouch can be biodegradable and water soluble, for example, a polyvinyl alcohol. The dry pouch containing the fragrance delivery system can be packaged in a box or tube out of which they can be pulled by hand or after being attached to the stick device. If desired, any physical contact between the consumer's hand and the pouch can be avoided by attaching and releasing the pouch to and from the stick without manually touching the pouch.

As illustrated in the Example, the fragrance delivery system of the present invention provides significantly superior fragrance retention in a powdered detergent composition. As further illustrated below other perfumed powder compositions contained in semi-closed packaging systems are subject to fragrance evaporation which can lead to total perfume loss during storage.

### EXAMPLES

Spray dried fragrance delivery systems were produced by using one of the four disclosed systems in Table 1. The dry ingredients were mixed with water at a temperature around 40° C. in a suitable mixing vessel until thoroughly dissolved. The fragrance oil was added to the water mixture and emulsified at high shear until the fragrance/water mixture formed a stable emulsion. Utilizing a suitable spray dryer, such as an Anhydro #1 size pilot dryer, the emulsion was fed to the dryer under the following conditions: the inlet temperature was below 200° C. and the outlet temperature did not exceed 95° C. The dried product was then collected and packaged.

TABLE I

| Spray Dried | Percent | | |
|---|---|---|---|
| Fragrance | Fragrance | | Percent |
| System | Oil | Matrix Composition | Water |
| INCAP HC | 25% | 25% Hi-Cap ® 100 Starch | 50% |
| System | | (National Starch and Chemical, | |
| | | Bridgewater, New Jersey) | |
| Standard | 25% | 20% Capsul ® Starch | 50% |
| INCAP | | (National Starch and Chemical, | |
| System | | Bridgewater, New Jersey) and 5% | |
| | | Mannitol (SPI Polyolf Inc., New | |
| | | Castle, Delaware) | |
| Fast-Cap M | 20% | 6% Capsul ® Starch | 50% |
| System | | (National Starch and Chemical, | |
| | | Bridgewater, New Jersey) and | |
| | | 24% Maltrin M2509 (Grain | |
| | | Processing Corporation, | |
| | | Muscatine, Iowa) | |
| Polycap ® | 25% | 22.5% Hi-Cap ® 100 Starch | 50% |
| HC System | | (National Starch and Chemical, | |
| | | Bridgewater, New Jersey) and | |
| | | 2.5% Mowiol 3-98 PVOH | |
| | | (Hoechst Celanese Corporation, | |
| | | Charlotte, North Carolina) | |

### COMPARATIVE EXAMPLE

An unperfumed composition was prepared with the following formulation: 10.0% Stepanol WA-100 (sodium lauryl sulfate) supplied by Stepan Company, 49.5% Nacconol 90G (sodium alkylbenzene sulfonate) supplied by Stepan Company, 40.0% sodium sesquicarbonate and 0.5% BTC 824 P100 (N-tetradecyl dimethyl benzyl ammonium chloride monohydrate) supplied by Stepan Company.

Five comparative samples were prepared by adding various fragrance delivery systems to the un-perfumed composition prepared in accordance with the above formulation.

TABLE II

| | % Un-perfumed | % Fragrance |
|---|---|---|
| Sample | Composition | Composition |
| A (Comparison) | 95% | 5% “Lemon Fragrance” |
| | | (Haarmann and Reimer |
| | | fragrance L31058/492609) |
| B | 89.4% | 10.6% I31058/hc/60 INCAP |
| | | (47% fragrance load |
| | | (Haarmann and Reimer |
| | | fragrance L31058/492609)) |
| C (Comparison) | 93.3% | 1.7% Fumed Silica (Cab-O |
| | | Sil Grade 5, Cabot |
| | | Corporation, Tuscola, II.) |
| | | and |
| | | 5.0% “Lemon Fragrance” |
| | | (Haarmann and Reimer |
| | | fragrance L31058/492609) |
| D (Comparison) | 75.0% | 20.0% Rombach Light |
| | | Sulfate (HammChemie |
| | | GmbH, Oberhausen, |
| | | Germany) and |
| | | 5.0% “Lemon Fragrance” |
| | | (Haarmann and Reimer |
| | | fragrance L31058/492609) |
| E (Comparison) | 87.5% | 12.5% capsule based on |
| | | interfacial polymerization |
| | | of Melamine and |
| | | Formaldehyde (diameter |
| | | 60 micron) and 40% |
| | | “Lemon Fragrance” |
| | | (Haarmann and Reimer |
| | | fragrance L31058/492609) |

The above samples were placed in 1 oz-glass jars. The opening was closed with a paper towel in order to simulate a semi-closed system comparable to the dry pouch. The covered jars were placed in a 38° C. oven and evaluated after 1, 2 and 6 weeks. The perfume strength was evaluated by impact when smelled out of jar and after dissolving the detergent sample in water (1 g sample in 30 g water). The perfume impact was rated by using a scale from 1-5 with 1=no impact and 5=very strong impact.

TABLE III

| | Week 1 | | Week 2 | | Week 6 | |
|---|---|---|---|---|---|---|
| | Out of | | Out of | In | Out of | |
| Sample | Jar | In Water | Jar | Water | Jar | In Water |
| A | 5 | 3 | 4.5 | 2.5 | 1.5 | 0 |
| B | 2 | 4 | 1.5 | 4 | 0.5 | 4 |
| C | 5 | 3 | 4.5 | 1.5 | 1.5 | 0 |
| D | 4 | 3 | 3.5 | 1 | 1.5 | 0 |
| E | 3 | 2 | 2.5 | 0 | 0.5 | 0.5 |

This Comparative Example illustrates that the spray dried fragrance delivery system utilized in the dry pouch of the present invention provides significantly superior fragrance retention in a powdered detergent composition.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed:

1. A powder composition, wherein the powder composition comprises a fragrance delivery system comprising a matrix composition and a liquid fragrance composition, wherein the liquid fragrance composition is dispersed throughout the matrix composition.

2. The powder composition of claim 1, further comprising an effective amount of an anionic surfactant and about 0.01 to about 60 wt. % of the liquid fragrance composition.

3. The powder composition of claim 2, wherein the anionic surfactant is selected from the group consisting of alkylbenzenesulfonate salts, alkyl ether sulfate salts, alkyl sulfate salts, sulfosuccinate salts, paraffin sulfonate salts, alpha olefin sulfonate salts, methyl ester sulfonate salts, alkyl polyglycol phosphate salts and mixtures thereof.

4. The powder composition of claim 1, wherein the matrix composition is selected from the group consisting of starches, modified starches, polyvinyl alcohol, spray dried porous salts, clays, fumed silicas and mixtures thereof.

5. The powder composition of claim 2 further comprising a nonionic surfactant.

6. The powder composition of claim 5, wherein the nonionic surfactant is selected from the group consisting of ethoxylated aliphalic alcohols, ethoxylated alkyl phenols, ethoxylated carboxylic acids, polyethylene glycol diesters of fatty acids, fatty acid esters of ethoxylated sorbitans, polypropylene glycol-polyethylene glycol block copolymers and mixtures thereof.

7. The powder composition of claim 2 further comprising an amphoteric surfactant.

8. The powder composition of claim 7, wherein the amphoteric surfactant is selected from the group of betaines.

9. The powder composition of claim 2 further comprising another anionic surfactant selected from the group consisting of alkyl dimethyl benzyl ammonium chlorides, para-hydroxybenzoic acid, 2,4,4′-trichlro-2′hydroxy diphenyl ether, hypochlorite salts, peroxide compounds, percarbonate salts and perborate salts.

10. The powder composition of claim 2 further comprising a builder substance.

11. The powder composition of claim 10, wherein the builder substance is selected from the group consisting of citric acid, polyphosphates, polycarboxylates, carbonates, aluminosilicates, phosphonic acids, nitrilotriacetic acids, ethylenediamine, tetraacetic acid, sesquicarbonates, bicarbonates and sodium silicates.

12. The powder composition of claim 2 further comprising a buffer substance.

13. The powder composition of claim 12, wherein the buffer substance is selected from the group consisting of carbonates, bicarbonates, sesquicarbonates, phosphates, polyphosphates, metal hydroxides and mixtures thereof.

14. The power composition of claim 1, wherein the matrix is selected from the group consisting of starches, modified starches, polyvinyl alcohol, spray dried porous salts, clays, fumed silicas and mixtures thereof.

15. The powder composition of claim 1, wherein the fragrance composition is a spray dried fragrance.

16. The powder composition of claim 2, wherein the anionic surfactant is present in the range of about 0.01 to about 99.9 wt. %.

17. The powder composition of claim 5, wherein the nonionic surfactant is present in the range of about 0.01 to about 50 wt. %.

18. The powder composition of claim 7, wherein the amphoteric surfactant is present in the range of about 0.01 to about 30 wt. %.

19. The powder composition of claim 10, wherein the builder composition is present in the range of about 0.1 to about 80 wt. %.

20. The powder composition of claim 12, wherein the buffer composition is present in the range of about 0.1 to about 60 wt. %.

21. A handheld dry cleaning pouch containing a powder composition wherein the powder composition comprises a fragrance delivery system comprising a matrix composition and a liquid fragrance composition, wherein the liquid fragrance composition is dispersed throughout the matrix composition.

22. The cleaning pouch of claim 21, wherein the powder composition further comprises an effective amount of an anionic surfactant and about 0.01 to about 60 wt. % of the liquid fragrance composition.

23. The cleaning pouch of claim 21, wherein the matrix composition is selected from the group consisting of starches, modified starches, polyvinyl alcohol, spray dried porous salts, clays, fumed silicas and mixtures thereof.

24. The cleaning pouch of claim 21, wherein the fragrance composition is a spray dried fragrance.

25. A brush having a disposable dry pouch containing powder composition wherein the powder composition comprises a fragrance delivery system comprising a matrix composition and a liquid fragrance composition, wherein the liquid fragrance composition is dispersed throughout the matrix composition.

26. The brush of claim 25, wherein the powder composition further comprises an effective amount of an anionic surfactant and about 0.01 to about 60 wt. % of the liquid fragrance composition.

27. The brush of claim 25, wherein the matrix composition is selected from the group consisting of starches, modified starches, polyvinyl alcohol, spray dried porous salts, clays, fumed silicas and mixtures thereof.

28. The brush of claim 25, wherein the fragrance composition is a spray dried fragrance.
